(19) United States
(12) Patent Application Publication
(10) Pub. No.: US 2014/0099002 A1
(43) Pub. Date: Apr. 10, 2014

(54) APPARATUS AND METHOD FOR PROVIDING DIGITAL DRAWING

(71) Applicant: SAMSUNG TECHWIN CO., LTD., Changwon-city (KR)

(72) Inventor: Hyuck-Rae KIM, Changwon-city (KR)

(73) Assignee: Samsung Techwin Co., LTD., Changwon-City (KR)

(21) Appl. No.: 13/866,076

(22) Filed: Apr. 19, 2013

(30) Foreign Application Priority Data
Oct. 10, 2012 (KR) 10-2012-0112658

(51) Int. Cl. H04N 1/23

(52) U.S. Cl. CPC H04N 1/23
USPC 382/113

(57) ABSTRACT

An apparatus and method for providing a digital drawing in which equipment information or control point information of an analog computer aided design (CAD) drawing relating to interior equipment of a building and relative position information of the equipment information or the control point information of the analog CAD drawing are obtained from a scan drawing obtained by scanning the analog CAD drawing. The obtained information is displayed according to a user input based on the equipment information or control point information and the relative position information of the equipment information or the control point information in combination with the scan drawing.

### CROSS-REFERENCE TO RELATED PATENT APPLICATION

This application claims priority from Korean Patent Application No. 10-2012-0112658, filed on Oct. 10, 2012, in the Korean Intellectual Property Office, the disclosure of which is incorporated herein in its entirety by reference.

### BACKGROUND

1. Field

Exemplary embodiments relate to an apparatus and method of providing a digital drawing. More particularly, exemplary embodiments relate to an apparatus and method of providing a digital drawing, in which equipment information of an analog computer aided design (CAD) drawing or control point information of the analog CAD drawing, relating to interior equipment of a building and information regarding a relative position of the equipment or control point of the analog CAD drawing may be obtained from a scan drawing that is obtained by scanning the analog CAD drawing, and the equipment or control point information may be displayed on the scan drawing according to a user input based on a combination of the equipment or control point information, the information regarding the relative position, and the scan drawing.

2. Description of the Related Art

In a related art system, such as home automation (HA), factory automation (FA), intelligent building system (IBS), building automation system (BAS), and building energy management system (BEMS), in order to automatically perform management and control of a building, a user-customized graphic widget is mapped to equipment or a control point relating to interior equipment of a building. Input/output widgets that input a control instruction for the graphic widget and output the result of inputting the control instruction are provided in a graphical user interface in a single operation view, for a convenience of user management and control.

According to the related art, in order to generate an operation view, an engineer checks an analog computer aided design (CAD) drawing for generating a user-customized operation view for a particular operation, manually draws a graphic widget and input/output widgets of the operation view, and manually maps the graphic widget and the input/output widgets of the operation view to a related control point.

In the related art method of manually generating the operation view, a great amount of time and effort is required to check equipment or control point information, included in the analog CAD drawing.

Thus, when the operation view is generated based on the analog CAD drawing, a technique is needed for an engineer to easily generate the operation view, while checking equipment and control point information of the analog CAD drawing.

### SUMMARY

Exemplary embodiments may provide an apparatus and method for providing a digital drawing in which, when a user generates an operation view based on an analog computer aided design (CAD) drawing, the user may check equipment and control point information of the analog CAD drawing conveniently.

Technical problems to be solved by the exemplary embodiments are not limited to the technical problems described above, and other unmentioned technical problems will be clearly understood by those of ordinary skill in the art from the following description.

According to an aspect of the exemplary embodiments, there is provided an apparatus for providing a digital drawing, the apparatus including: a scan drawing receiving device which receives a scan drawing obtained by scanning an analog computer aided design (CAD) drawing; a scan drawing decryption device which recognizes symbol data included in the received scan drawing and obtains information regarding relative positions of the recognized symbol data in the received scan drawing; a data converter which converts the recognized symbol data into equipment information or control point information of the analog CAD drawing by referring to a data structure scheme in which data relations of the symbol data in the received scan drawing are defined, associates the relative positions of the obtained information with the equipment information or the control point information of the analog CAD drawing, and stores the obtained information based on the associating; and a controller which controls the scan drawing receiving device, the scan drawing decryption device, and the data converter of the apparatus, to display the received scan drawing, receive a user position selection on the displayed scan drawing, and display the equipment information or the control point information of the analog CAD drawing associated with the relative positions of the obtained information corresponding to the user position selection.

According to another aspect of the exemplary embodiments, there is provided a method for providing a digital drawing, the method including: receiving a scan drawing which is obtained by scanning an analog computer aided design (CAD) drawing; recognizing symbol data which is included in the received scan drawing and obtaining information regarding relative positions of the recognized symbol data included in the received scan drawing; converting the recognized symbol data into equipment information or control point information of the analog CAD drawing by referring to a data structure scheme in which data relations of the symbol data in the received scan drawing are defined, associating the relative positions of the obtained information with the equipment information or the control point information of the analog CAD drawing, and storing the obtained information based on the associating; displaying the received scan drawing; receiving a user position selection on the displayed scan drawing; and displaying the equipment information or the control point information of the analog CAD drawing associated with the relative positions of the obtained information corresponding to the user position selection.

### BRIEF DESCRIPTION OF THE DRAWINGS

The above and other features and advantages of the exemplary embodiments will become more apparent by describing in detail exemplary embodiments thereof with reference to the attached drawings in which:

FIG. 1 is a block diagram for describing the structure of an apparatus for providing a digital drawing according to an exemplary embodiment;

FIG. 2 is a flowchart illustrating a method for providing a digital drawing according to an exemplary embodiment; and

FIGS. 3A through 3F illustrate an operation of generating a user-customized operation view according to an exemplary embodiment.

### DETAILED DESCRIPTION OF THE EXEMPLARY EMBODIMENTS

Expressions such as “at least one of,” when preceding a list of elements, modify the entire list of elements and do not modify the individual elements of the list.

The following description illustrates a principle of the exemplary embodiments. Thus, although not clearly described or shown in the specification, those of ordinary skill in the art may implement the principle of the exemplary embodiments and may invent various apparatuses that conform to the concept and scope of the exemplary embodiments. Also, all conditional terms and embodiments enumerated in the specification should be understood to be clearly intended to understand the concept of the exemplary embodiments and not to be limited to particularly enumerated embodiments and states. In addition, all detailed descriptions of a particular embodiment in addition to the principles, viewpoints, and embodiments of the exemplary embodiments should be understood to include structural and functional equivalents thereof. Furthermore, these equivalents should be understood to include currently-known equivalents and equivalents to be developed in the future, i.e., all equivalents invented to perform the same function regardless of structures.

Thus, functions of various elements including a processor or a functional block indicated in a concept similar to that of the processor may be provided using hardware capable of executing software in relation to appropriate software in addition to dedicated hardware. When the functions are provided by the processor, the functions may be provided by a single dedicated processor, a single shared processor, or a plurality of individual processors, and part thereof may be shared. Also, the use of terms representing a processor, control, or concept similar to that of the processor or control are not limited exclusively to hardware capable of executing software and should be understood to include digital signal processor (DSP) hardware, ROM, RAM, and a non-volatile memory for storing software. Other well-known hardware may be included.

The above-described purposes, features, and advantages will be more apparent from the following detailed description relating to the attached drawings. When describing the exemplary embodiments, if it is determined that the detailed description of the related art may unnecessarily make the point of the exemplary embodiments vague, the detailed description will be omitted or summarized.

When a device “comprises” an element, it means that the device may not exclude another element, but may further comprise another element unless there is a description indicating otherwise.

Hereinafter, the exemplary embodiments will be described in detail by explaining preferred embodiments with reference to the attached drawings.

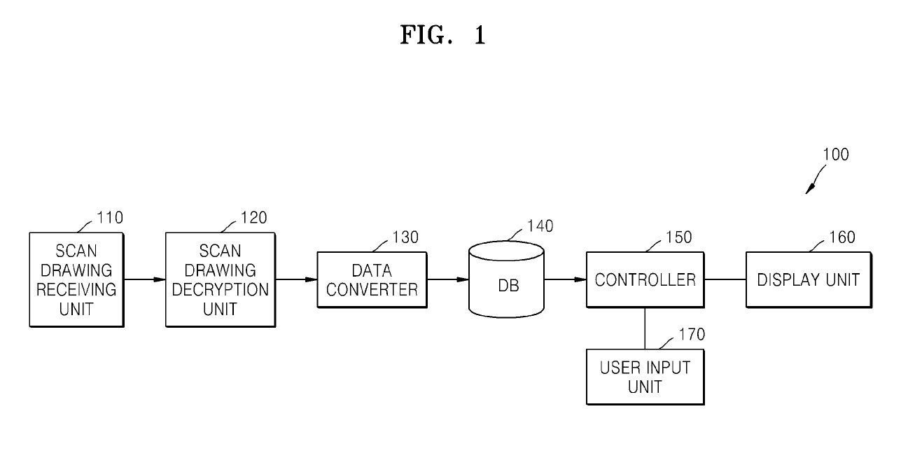

FIG. 1 is a block diagram for describing the structure of an apparatus for providing a digital drawing 100 according to an exemplary embodiment.

Referring to FIG. 1, the apparatus for providing a digital drawing 100 according to the present embodiment includes a scan drawing receiving unit 110, a scan drawing decryption unit 120, a data converter 130, a database 140, a controller 150, a display unit 160, and a user input unit 170. It is obvious that elements other than the above-described elements may be included in the apparatus for providing a digital drawing 100.

At least part of the scan drawing receiving unit 110, the scan drawing decryption unit 120, the data converter 130, the database 140, the controller 150, the display unit 160, and the user input unit 170 of the apparatus for providing a digital drawing 100 according to the present embodiment may be program modules that communicate with an external terminal device or an external server. These program modules, such as operating system (OS) and application program modules and other program modules, may be included in the apparatus for providing a digital drawing 100, and may be physically stored in various types of known memory devices. Also, these program modules may be stored in a remote memory device that may communicate with the apparatus for providing a digital drawing 100. Examples of the program modules include routines, sub routines, programs, objects, components, and data structures that perform particular functions that will be described below or that implement particular abstract data types. However, aspects of the exemplary embodiments are not limited.

The apparatus for providing a digital drawing 100 according to the present embodiment may be included in or connected to a digital device, such as a personal computer (PC) (e.g., a desktop computer, a laptop computer, a tablet computer, a palm top computer, etc.), a workstation, a personal digital assistant (PDA), a web pad, or a mobile phone.

The scan drawing receiving unit 110 is an element for performing a function of receiving a scan drawing, which is obtained by scanning an analog computer aided design (CAD) drawing regarding interior equipment of a building and may include a digital image data generator, such as a scanner or a digital camera, or may be connected.

The scan drawing according to the present embodiment includes a plurality of digital images, each including different information. Each of the plurality of digital images includes information indicative of symbol data, and may be classified as an execution drawing or a diagram drawing according to the type of included information in each digital image.

Thus, when the scan drawing including a plurality of digital images is received, at least part of each digital image may be designated by a user as one of the execution drawing and the diagram drawing.

The execution drawing is a digital image illustrating an internal structure of the building by arranging identification symbols relating to equipment or a control point of the building in relative positions corresponding to actual positions of the building. The diagram drawing is a digital image in which the identification symbols relating to the equipment or control point of the building and metadata of the equipment or control point of the building are described in the form of a table.

The identification symbols include at least one of names, abbreviations, keywords, drawing numbers, and drawing reference numerals of the equipment or control point of the building. The identification symbols generally conform with standards relating to a building drawing.

In the present embodiment, the scan drawing, including a plurality of digital images, may be generated when the user inputs the scan drawing by designating at least part of each digital image as one of the execution drawing and the diagram drawing, or may be automatically classified by a predetermined arithmetic operation processing algorithm stored in the scan drawing receiving unit 110. However, this is just one embodiment, and aspects of the exemplary embodiments are not limited thereto.

The scan drawing decryption unit 120 recognizes symbol data included in the scan drawing received by the scan drawing receiving unit 110, and obtains information regarding relative positions of the symbol data included in the scan drawing.

An optical character reader (OCR) technique according to the related art may be used when the symbol data included in the scan drawing is recognized by the scan drawing decryption unit 120. Thus, an OCR-based application program module and other program modules may be included as at least part of the scan drawing decryption unit 120. However, this is just one embodiment, and aspects of the exemplary embodiments are not limited thereto.

As described above, since the scan drawing according to the present embodiment generally includes a plurality of digital images, when the scan drawing receiving unit 110 classifies at least part of each digital image included in the scan drawing into either an execution drawing or a diagram drawing according to a user designation or the arithmetic operation processing algorithm stored in the scan drawing receiving unit 110, the scan drawing decryption unit 120 may extract symbol data that is commonly included in the execution drawing and the diagram drawing as identification symbols for the equipment or control point.

When the identification symbols conform with the standardized contents relating to the building drawing, standardized symbols, such as names, abbreviations, keywords, drawing numbers, and drawing reference numerals, which relate to the equipment or control point of the building, may be previously stored in the scan drawing receiving unit 110. Then only symbol data that is commonly included in the execution drawing and the diagram drawing and that conform with the previously-stored standardized symbols may be extracted as identification symbols. However, this is just one embodiment, and aspects of the exemplary embodiments are not limited thereto.

Furthermore, the scan drawing 120 may extract information from the execution drawing of the scan drawing, regarding relative positions in which the identification symbols for the equipment or control point are arranged,.

The data converter 130 converts the symbol data into equipment or control point information of the analog CAD drawing by referring to a data structure scheme in which data relations of the symbol data included in the scan drawing is defined, and associates the information regarding the relative positions of the identification symbols with the equipment or control point information converted from the symbol data so as to store the associated information in the database 140.

The metadata of the equipment or control point may be obtained by converting the symbol data extracted from the diagram drawing.

In this case, the relative position information of the symbol data obtained from the execution drawing is associated with the metadata of the equipment or control point obtained from the diagram drawing by using the identification symbols of the symbol data as reference keys, so that the associated information may be stored in the database 140 in the form of a table.

The display unit 160 may display the scan drawing received by the scan drawing receiving unit 110 or the equipment or control point information stored in the database 140, by using the data converter 130 in response to a driving signal received from the controller 150. The display unit 160 may provide visual information or auditory information to the user. The display unit 160 may include a display panel that uses a liquid crystal display (LCD), a thin film transistor (TFT), or an organic electroluminescence (EL) as an element, so as to provide visual information. When the display unit 160 includes a touch screen, the display unit 160 may be configured to simultaneously operate as the user input unit 170.

When the scan drawing is displayed on the display unit 160, the user input unit 170 transmits the user position selection onto the displayed scan drawing, and transfers the input user position selection to the controller 150.

The controller 150 may control the elements of the apparatus for providing a digital drawing 100 to receive the input user position selection on the scan drawing from the user input unit 170, while the scan drawing received from the scan drawing receiving unit 110 is displayed on the display unit 160, to obtain relative position information corresponding to the input user position selection, to check equipment or control point information associated with the obtained relative position information. In particular, the controller 150 may control the above elements of the apparatus to check the metadata of the equipment or control point from the database 140, and to display the checked equipment or monitoring control point information on the display unit 160.

Furthermore, the controller 150 may be configured to automatically generate a user-customized operation view. For example, the controller 150 may control the elements of the apparatus for providing a digital drawing 100 to add a widget that is mapped to the equipment or control point information associated with the relative position information, corresponding to the user position selection onto a window that is different from a window on which the scan drawing is displayed, and to display the widget on the window.

In the present embodiment, the window on which the scan drawing is displayed or the automatically-generated user-customized operation view may be provided in the form of a web application or a component of the web application. In this case, the controller 150 may include an application program module and other program modules that follow a web standard, such as HTML 5, so as to drive and control the display unit 160 and the user input unit 170. In this way, according to the present embodiment, when a control function is performed according to the web standard, such as HTML 5, the application program module for performing the control function may be easily inserted into other web application programs so that the applicability of the apparatus for providing a digital drawing 100 may be further improved.

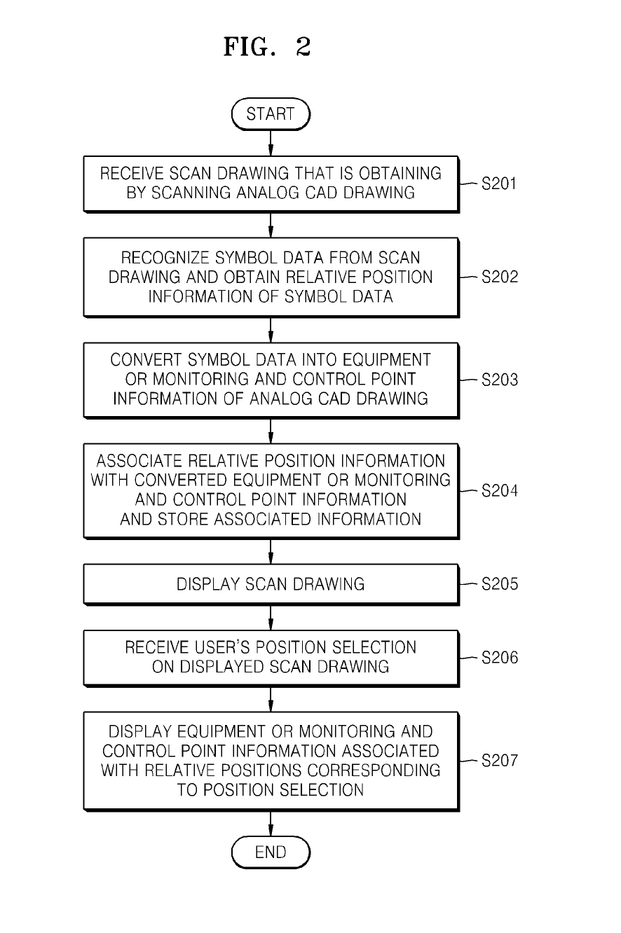

FIG. 2 is a flowchart illustrating a method for providing a digital drawing according to an exemplary embodiment. The method for providing a digital drawing according to the present embodiment may be performed by the apparatus for providing a digital drawing 100 illustrated in FIG. 1. Thus, the similar aspects, as those of the apparatus for providing a digital drawing 100 illustrated in FIG. 1, will be referred to in reference to FIG. 1.

A scan drawing that is obtained by scanning an analog CAD drawing relating to interior equipment of a building is received (S201).

The scan drawing, according to the present embodiment, includes a plurality of digital images each including different information, and at least part of each digital image may be classified as either an execution drawing or a diagram drawing according to the type of information indicating symbol data included in each digital image.

When the scan drawing including a plurality of digital images is received in operation S201, at least part of each digital image may be designated by a user as one of the execution drawing and the diagram drawing. Alternatively, at least part of each digital image may be automatically classified based on a predetermined arithmetic operation processing algorithm.

The symbol data included in the scan drawing received in operation S201 is recognized in operation S201, and relative position information of the symbol data in the received scan drawing is obtained (S202).

When the symbol data included in the received scan drawing is recognized in operation S202, the symbol data that is commonly included in the execution drawing and the diagram drawing of the scan drawing received in operation S201 may be extracted as identification symbols for equipment or a control point.

After the identification symbols for equipment or a control point are extracted, information regarding the relative positions of the symbol data of the execution drawing may be extracted as position information of the equipment or control point. Furthermore, a character row of the diagram drawing that the symbol data of the diagram drawing is located in may be extracted as metadata of the equipment or control point.

The symbol data included in the received scan drawing is converted into equipment or control point information of the analog CAD drawing by referring to a data structure scheme in which data relations of the symbol data included in the scan drawing is defined (S203).

The obtained relative position information of the symbol data in the received scan drawing is associated with the equipment or control point information converted in operation S203, and is stored (S204). In this case, the relative position information of the symbol data obtained from the execution drawing may be associated with the metadata of the equipment or control point obtained from the diagram drawing by using the identification symbols of the symbol data as reference keys, so that the associated information may be stored in the form of a database table.

The scan drawing received in operation S201 is displayed on a display panel (S205).

A user position selection is input and reflected in the scan drawing displayed in operation S205 (S206).

The equipment or control point information that is associated with the relative position information corresponding to the user position selection input in operation S206 is displayed on the scan drawing of the display panel (S207).

Although not shown in FIG. 2, in an embodiment of the exemplary embodiments, a widget is mapped to the equipment or control point information, associated with the relative position information corresponding to the user position selection input to a user graphic interface. The widget is different from the displayed scan drawing, and displays the equipment or control point information on the scan drawing in operation S207. Thus, a user-customized operation view may be automatically generated and provided to the user.

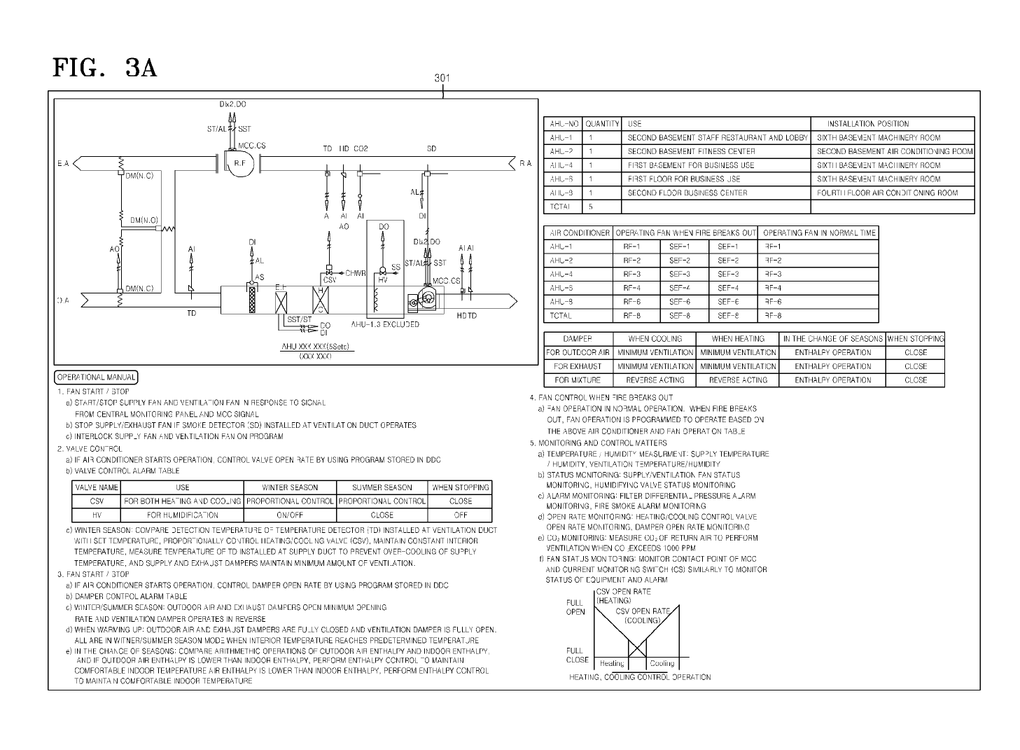

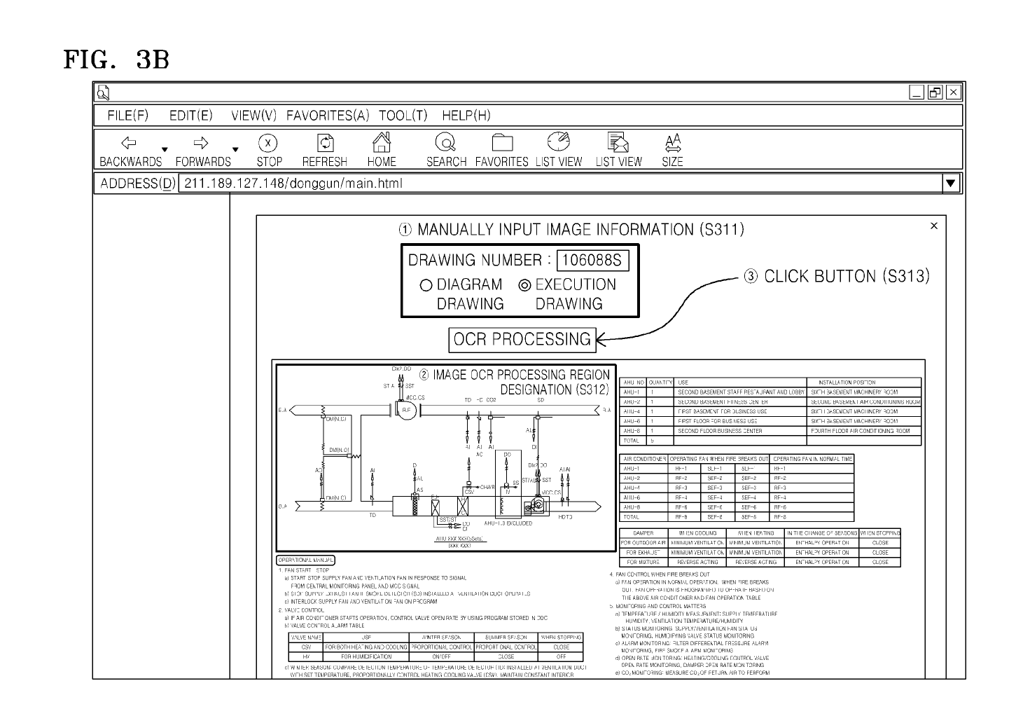

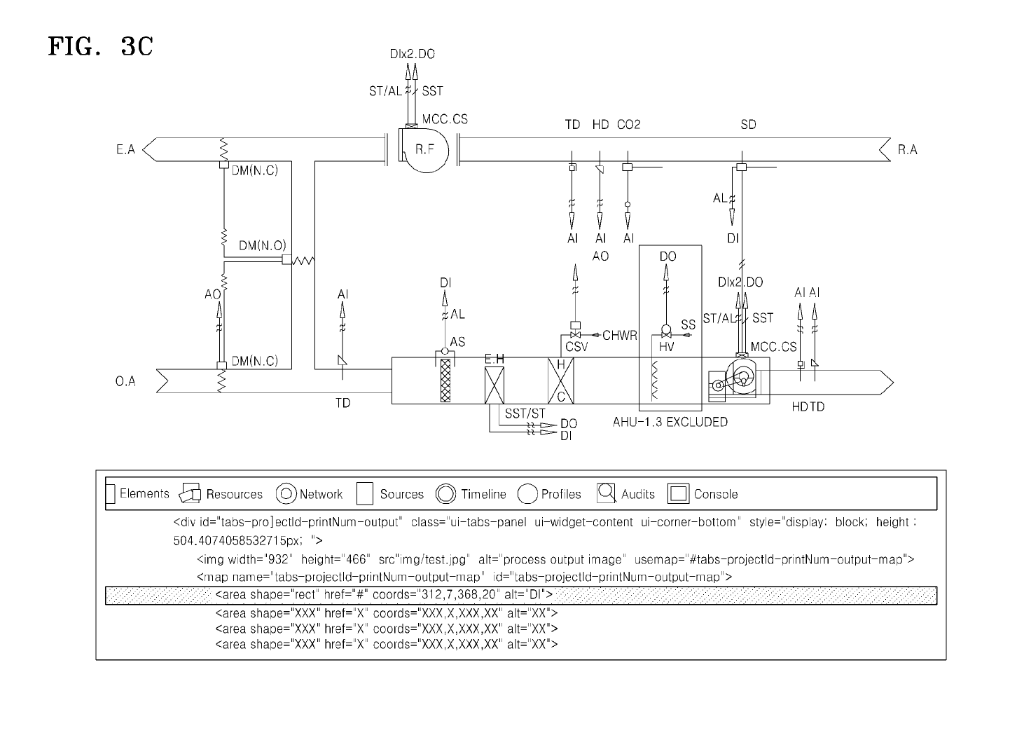

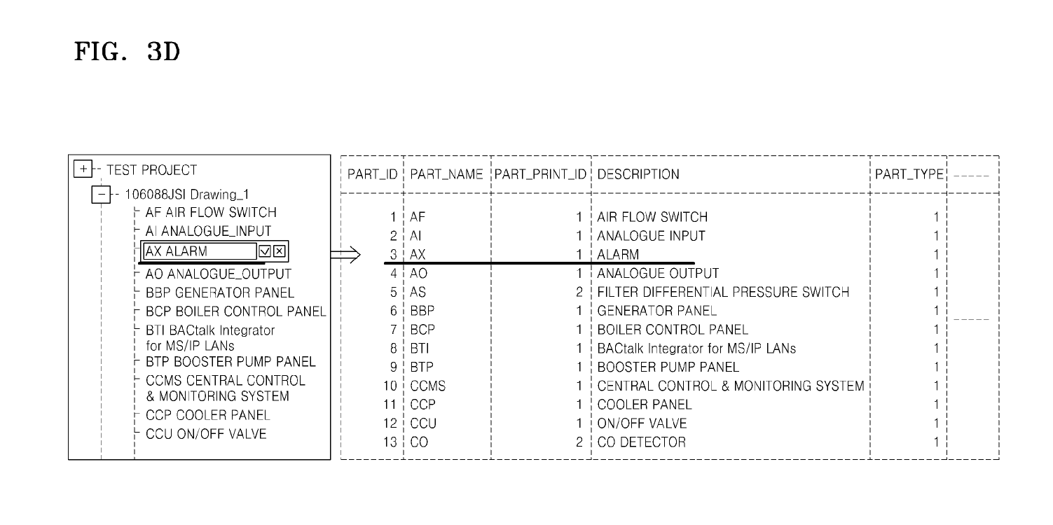

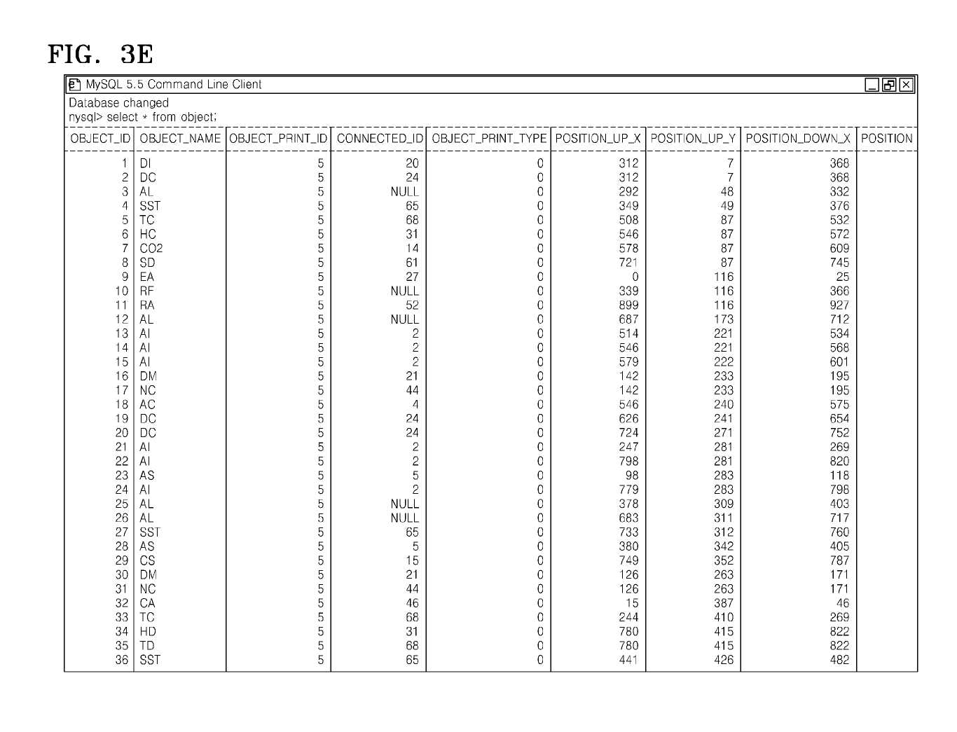

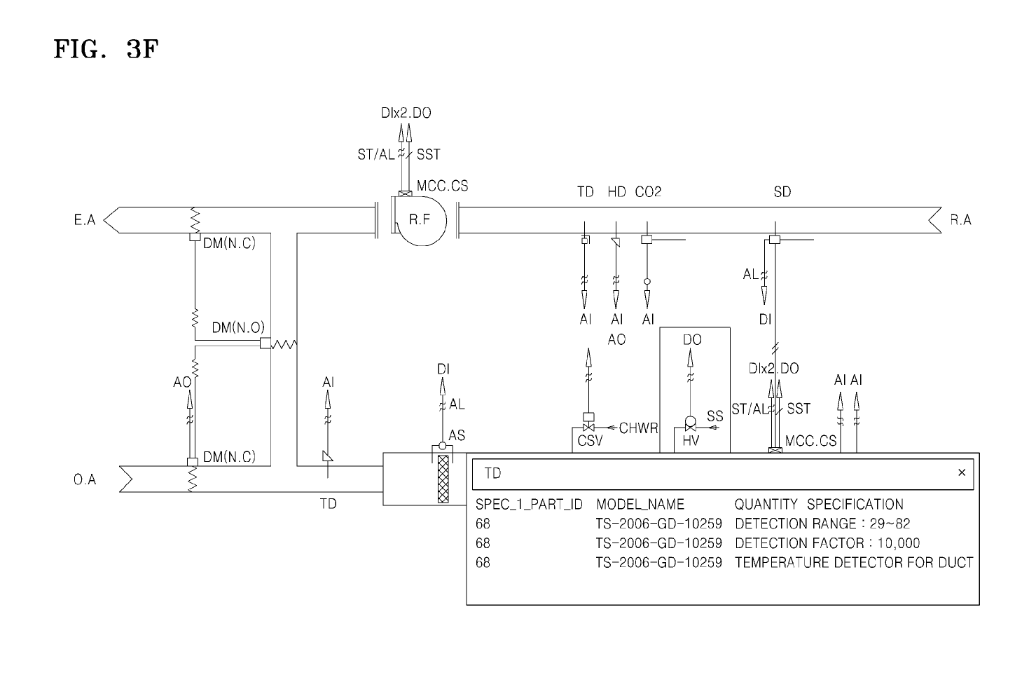

FIGS. 3A through 3F illustrate an operation of generating a user-customized operation view according to an exemplary embodiment.

FIG. 3A shows an example of a plurality of digital images that constitute a scan drawing, according to an embodiment.

Referring to FIG. 3A, the digital image of the scan drawing according to the present embodiment may include an execution drawing 301, as part of the digital image of the scan drawing.

FIG. 3B shows an example in which the user designates at least part of each digital image of the scan drawing as one of the execution drawing 301 and a diagram drawing.

Referring to FIG. 3B, the user manually inputs information designating whether drawing numbers of the digital images that constitute the scan drawing and at least part of the digital images that constitute the scan drawing are included in the execution drawing or the diagram drawing (S311).

A partial region of the digital images that constitute the scan drawing is manually designated as the execution drawing 301 to be OCR processed (S312).

Then, an OCR processing button is clicked (S313) so that the partial region of the digital images that constitute the scan drawing is manually designated as the execution drawing 301 are OCR processed, identification symbols for equipment or control point are extracted from the digital images, and information regarding relative positions of identification symbols on the execution drawing 301 may be extracted as position information of the equipment or control point.

FIG. 3C shows the result of performing OCR processing on the execution drawing 301 illustrated in FIG. 3A.

Referring to FIG. 3C, “DI” is an example of an identification symbol, among a plurality of identification symbols included in the execution drawing 301 of FIG. 3A, and is located in a rectangular region in which a left upward vertex of DI is located at a point corresponding to an X-Y coordinate (312, 7) and a right downward vertex is located at a point corresponding to an X-Y coordinate (368, 20).

FIG. 3D shows the result of converting symbol data, in particular, symbol data included in the diagram drawing of the scan drawing, into equipment or control point information of an analog CAD drawing by referring to a data structure scheme in which data relations of the symbol data included in the scan drawing is defined.

Referring to FIG. 3D, when an identification symbol on the scan drawing according to the present embodiment is equipment “AX”, the symbol data of the scan drawing, corresponding to AX may be converted into equipment or control point information so that the equipment may indicate “alarm”.

FIG. 3E shows a database table in which the equipment or control point information according to the present embodiment is stored.

Referring to FIG. 3E, the equipment or control point information according to the present embodiment is associated with data fields POSITION_UP_X, POSITION_UP_Y, POSITION_DOWN_X, and POSITION_DOWN_Y, relating to relative position information of the identification symbols by using the identification symbols for the equipment or control point as keys for referencing the associated information in a table stored in the database 140, and is stored in the form of a database table having a name “object”.

According to the present embodiment, the equipment and monitoring control point information included in the analog CAD drawing is digitalized so that storing, copying, and processing of the information may be easily performed.

FIG. 3F illustrates a graphic user interface that is provided by the apparatus for providing a digital drawing 100 illustrated in FIG. 1.

Referring to FIG. 3F, when a user selects a region of a displayed execution drawing in which an identification symbol “TD” is located, equipment or control point information 350 associated with relative positions corresponding to the user selected region overlaps the execution drawing and is displayed thereon. The user graphic interface, according to the present embodiment, may be implemented in the form of a web application or a component of the web application. In this way, when the user graphic interface is implemented according to a web standard, such as HTML 5, the user graphic interface may be easily inserted into other web application programs so that the applicability of the apparatus for providing a digital drawing 100 may be further improved.

According to the present embodiment, when a user generates an operation view based on an analog CAD drawing, the user may receive equipment or control point information by clicking a region of a digital drawing that is obtained by converting the analog CAD drawing, in which particular equipment or a particular control point is located. Thus, user productivity of generating the operation view may be greatly improved, and a mapping error relating to the equipment and control point while the operation view is generated may be minimized.

The exemplary embodiments can also be embodied as computer readable codes on a computer readable storage medium. The computer readable storage medium is any data storage device that can store data which can be thereafter read by a computer system. Examples of the computer readable storage medium include read-only memory (ROM), random-access memory (RAM), CD-ROMs, magnetic tapes, floppy disks, optical data storage devices, and carrier waves (such as data transmission through the Internet). The computer readable storage medium can also be distributed over network coupled computer systems so that the computer readable code is stored and executed in a distributed fashion. Also, functional programs, codes, and code segments for accomplishing the exemplary embodiments can be easily construed by programmers skilled in the art to which the exemplary embodiments pertain.

As described above, in an apparatus and method for providing a digital drawing according to the one or more embodiments, equipment and control point information included in an analog CAD drawing is digitalized so that storing, copying, and processing of the information may be easily performed, and when an operation view is generated based on the analog CAD drawing, a user has access to the digital drawing that is obtained by converting the analog CAD drawing to receive the equipment and control point information automatically, so that the productivity of generating the operation view may be greatly improved and a mapping error relating to the equipment and control point may be minimized.

While the exemplary embodiments has been particularly shown and described, it will be understood by those of ordinary skill in the art that various changes in form and details may be made therein without departing from the spirit and scope of the exemplary embodiments as defined by the following claims.

What is claimed is:

1. An apparatus for providing a digital drawing, comprising:
a scan drawing receiving device which receives a scan drawing obtained by scanning an analog computer aided design (CAD) drawing;
a scan drawing decryption device which recognizes symbol data included in the received scan drawing and obtains information regarding relative positions of the recognized symbol data in the received scan drawing;
a data converter which converts the recognized symbol data into equipment information or control point information of the analog CAD drawing by referring to a data structure scheme in which data relations of the symbol data in the received scan drawing are defined, associates the relative positions of the obtained information with the equipment information or the control point information of the analog CAD drawing, and stores the obtained information based on the associating; and
a controller which controls the scan drawing receiving device, the scan drawing decryption device, and the data converter of the apparatus, to display the received scan drawing, receive a user position selection on the displayed scan drawing, and display the equipment information or the control point information of the analog CAD drawing associated with the relative positions of the obtained information corresponding to the user position selection.

2. The apparatus of claim 1, wherein the controller controls the scan drawing receiving device, the scan drawing decryption device, and the data converter of the apparatus to:
add a widget which is mapped to the equipment information or the control point information of the analog CAD drawing associated with the relative positions of the obtained information corresponding to the user position selection, the widget is added to a first window, which is different from a second window on which the received scan drawing is displayed, and
display the widget on the first window.

3. The apparatus of claim 1, wherein the received scan drawing comprises:
identification symbols;
an execution drawing which illustrates an internal structure of a building by arranging the identification symbols relating to an equipment or a control point of the building in relative positions corresponding to actual positions of the building; and
a diagram drawing in which the identification symbols relating to the equipment or the control point of the building and metadata of the equipment or the control point of the building are described in a form of a table.

4. The apparatus of claim 3, wherein the identification symbols comprise
at least one of names, abbreviations keywords, drawing numbers, and drawing reference numerals of the equipment or the control point.

5. The apparatus of claim 3, wherein the scan drawing decryption device extracts symbol data which is commonly included in the execution drawing and the diagram drawing, as the identification symbols for the equipment or the control point.

6. The apparatus of claim 3, wherein the scan drawing decryption device extracts information regarding relative positions in which the identification symbols for the equipment or the control point are arranged in the execution drawing of the scan drawing.

7. The apparatus of claim 3, wherein the data converter associates the relative positions of the obtained information with the metadata of the equipment or the control point based on the identification symbols relating to the equipment or the control point such that the associated information is stored in a form of a database table.

8. The apparatus of claim 3, wherein the controller controls the scan drawing receiving device, the scan drawing decryption device, and the data converter of the apparatus to display the execution drawing of the received scan drawing.

9. A method of providing a digital drawing, the method comprising:
receiving a scan drawing which is obtained by scanning an analog computer aided design (CAD) drawing;
recognizing symbol data which is included in the received scan drawing and obtaining information regarding relative positions of the recognized symbol data in the received scan drawing;
converting the recognized symbol data into equipment information or control point information of the analog CAD drawing by referring to a data structure scheme in which data relations of the symbol data in the received scan drawing are defined, associating the relative positions of the obtained information with the equipment information or the control point information of the analog CAD drawing, and storing the obtained information based on the associating;
displaying the received scan drawing;
receiving a user position selection on the displayed scan drawing; and
displaying the equipment information or the control point information of the analog CAD drawing associated with the relative positions of the obtained information corresponding to the user position selection.

10. The method of claim 9, further comprising:
adding a widget which is mapped to the equipment information or the control point information of the analog CAD drawing associated with the relative positions of the obtained information corresponding to the user position selection, the widget is added to a first window, which is different from a second window, on which the received scan drawing is displayed.

11. The method of claim 9, wherein the received scan drawing comprises:
identification symbols;
an execution drawing which illustrates an internal structure of a building by arranging the identification symbols relating to an equipment or a control point of the building in relative positions corresponding to actual positions of the building; and
a diagram drawing in which the identification symbols relating to the equipment or the control point of the building and metadata of the equipment or the control point of the building are described in a form of a table.

12. The method of claim 10, wherein the recognizing of the symbol data comprises:
extracting symbol data which is commonly included in the execution drawing and the diagram drawing, as the identification symbols for the equipment or the control point;
extracting information regarding relative positions of the symbol data in the execution drawing as position information of the equipment or the control point; and
extracting a character row that the symbol data of the diagram drawing is located in as metadata of the equipment or the control point.

13. The method of claim 10, wherein the identification symbols comprise
at least one of names, abbreviations, keywords, drawing numbers, and drawing reference numerals of the equipment or the control point.

14. The method of claim 10, wherein the converting of the symbol data comprises associating the relative positions of the obtained information with metadata of the equipment or the control point based on the identification symbols relating to the equipment or the control point such that the associated information is stored in a form of a database table.

15. The method of claim 10, wherein the displaying of the received scan drawing comprises displaying the execution drawing of the received scan drawing.
